(19) United States
(12) Patent Application Publication
(10) Pub. No.: US 2003/0063242 A1
(43) Pub. Date: Apr. 3, 2003

(54) Liquid crystal display device and electronic apparatus

(75) Inventors: Joji Nishimura, Fujimi-cho (JP); Tsuyoshi Maeda, Fujimi-cho (JP); Osamu Okumura, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/245,377

(22) Filed: Sep. 18, 2002

(30) Foreign Application Priority Data
Sep. 18, 2001 (JP) 2001-283425

(51) Int. Cl. G02F 1/1335

(52) U.S. Cl. 349/113

(57) ABSTRACT

The invention provides a liquid crystal display device that performs bright display in a wide range of viewing angles. A liquid crystal display device of the present invention includes a pair of substrates facing each other, with a liquid crystal layer therebetween. A reflective layer, including a holographic reflective layer or a cholesteric reflective layer, is formed on the opposing substrate. A light scattering layer, including a forward scattering film, is provided on the upper surface of the element substrate.

### BACKGROUND OF THE INVENTION

1. Field of Invention

The present invention relates to liquid crystal display devices and electronic apparatus. In particular, the present invention relates to the configuration of a liquid crystal display device which is preferable for using new types of reflector, such as cholesteric reflectors and holographic reflectors, other than known metallic reflectors.

2. Description of Related Art

Reflective liquid crystal display devices consume relatively little electrical power because they do not have a light source, such as a backlight, and have been commonly used as display units mounted in various portable electronic apparatus and devices. A metallic film having a high reflectivity, such as aluminum or silver, has been used as a reflective layer of such reflective liquid crystal display devices. Recently, however, a dielectric mirror in which dielectric thin films having different refractive indexes are laminated one on another, a cholesteric reflector using a cholesteric liquid crystal, a holographic reflector using a holographic element, and so on, have been proposed.

Among them, the cholesteric liquid crystal exhibits a liquid crystal phase at a predetermined temperature (liquid crystal transition temperature) or more, and liquid crystal molecules have a periodical helical configuration at a predetermined pitch in the liquid crystal phase. With this configuration, the cholesteric liquid crystal selectively reflects light having a wavelength corresponding to the helical pitch and allows other light to pass therethrough. Further, since the helical pitch can be controlled by the orientation temperature, the color of the reflected light can be changed by changing the orientation temperature. Accordingly, the cholesteric liquid crystal can be used as a reflective color filter.

The holographic element has a so-called off axis function, in which incident light is reflected in a direction deviating from the direction of specular reflection in accordance with the pitch of interference fringes formed in the element. By changing the pitch of the interference fringes, light having different wavelengths can be reflected, and the holographic element can also be used as a reflective color filter, like the cholesteric liquid crystal.

These new-type reflectors have a unique function, as described above, and can realize display with high luminance and high color-purity compared to metallic reflective layers which have been commonly used. Accordingly, these new reflectors may enhance the display quality of reflective liquid crystal display devices.

### SUMMARY OF THE INVENTION

However, the above-described reflectors have a problem in that the viewing angle is essentially narrow compared to the related art reflective layers that include a metallic film. FIG. 7 shows an example of the configuration of a related art reflective liquid crystal display device. A liquid crystal layer 103 is sandwiched between an upper substrate 101 and a lower substrate 102, and a reflective layer 104, such as a cholesteric reflective layer or a holographic layer, is provided on the upper surface of the lower substrate 102. In this liquid crystal display device, light LI from above the upper substrate 101 passes through the upper substrate 101 and the liquid crystal layer 103, is reflected at the reflective layer 104, and again passes through the liquid crystal layer 103 and the upper substrate 101 in this order so as to reach the eyes of a user. However, this type of reflective layer creates reflection light having high directivity. Accordingly, when the user views the display of the liquid crystal display device from within a limited narrow angle range, the display is much brighter than other related art displays. However, the display is dark when viewed from other positions.

The present invention addresses or solves the above-described problems, and provides a liquid crystal display device in which a bright display can be achieved over a wide range of viewing angles.

In order to address the above problems, a liquid crystal display device of the present invention includes a pair of substrates facing each other with a liquid crystal therebetween; and a reflective layer formed on one of the pair of substrates. The reflective layer includes a cholesteric reflective layer. The other substrate is disposed at a viewing side. A light scattering layer to scatter light reflected at the reflective layer is provided at the viewing side above the reflective layer.

Another liquid crystal display device of the present invention includes a pair of substrates facing each other with a liquid crystal therebetween; and a reflective layer formed on one of the pair of substrates. The reflective layer includes a holographic reflective layer. The other substrate is disposed at a viewing side. A light scattering layer to scatter light reflected at the reflective layer is provided at the viewing side above the reflective layer.

In the liquid crystal display device of the present invention, the reflective layer creates reflected light having high directivity, such as a holographic reflective layer or a cholesteric reflective layer. However, since the light scattering layer is provided at the viewing side above the reflective layer, the reflected light scatters when it passes through the light scattering layer, and thus the intensity distribution of the reflected light can be even more than in the related art. As a result, a liquid crystal display device that performs bright display over a wide range of viewing angles can be realized.

A forward scattering film provided on the outer surface of the other substrate may be used as the light scattering layer. Alternatively, an internal scattering layer can be used which is formed on an inner side of the one substrate or the other substrate, and which is formed by mixing particles into a light permeability layer, where the refractive index of the particles is different from that of the light permeability layer. In particular, when the forward scattering film is provided on an outer surface of the other substrate, a scattering function can be added to the related art liquid crystal display device with a simple method.

Another liquid crystal display device of the present invention includes a pair of substrates facing each other with a liquid crystal therebetween; and a reflective layer formed on one of the pair of substrates. The reflective layer includes a cholesteric reflective layer. The other substrate is disposed at a viewing side. An upper surface of the one substrate is uneven and is provided with the reflective layer thereon.

Another liquid crystal display device of the present invention includes a pair of substrates facing each other with a liquid crystal therebetween; and a reflective layer formed on one of the pair of substrates. The reflective layer includes a holographic reflective layer. The other substrate is disposed at a viewing side. An upper surface of the one substrate is uneven and is provided with the reflective layer thereon.

By making the upper surface of the one substrate uneven and forming a cholesteric reflective layer or a holographic reflective layer thereon, instead of providing a separate light scattering layer as described above, the reflective layer itself has a scattering function. Accordingly, the intensity distribution of the reflected light can be even more than in the related art, as in the above case. As a result, a liquid crystal display device that performs bright display over a wide range of viewing angles can be realized.

An electronic apparatus of the present invention includes the liquid crystal display device of the present invention. With this configuration, the electronic apparatus that includes a liquid crystal display unit and that has excellent visibility can be realized.

### BRIEF DESCRIPTION OF THE DRAWINGS

FIG. 1 is an exploded perspective view showing a schematic configuration of a reflective liquid crystal display device of a first embodiment of the present invention;

FIG. 2 is a sectional view showing a schematic configuration of the reflective liquid crystal display device;

FIG. 3 is a sectional view showing a schematic configuration of a reflective liquid crystal display device of a second embodiment of the present invention;

FIG. 4 is a perspective view showing an example of electronic apparatus including the liquid crystal display device;

FIG. 5 is a perspective view showing another example of electronic apparatus;

FIG. 6 is a perspective view showing still another example of electronic apparatus;

FIG. 7 is a sectional view showing a schematic configuration of a related art reflective liquid crystal display device.

### DETAILED DESCRIPTION OF PREFERRED EMBODIMENTS

[First Embodiment]

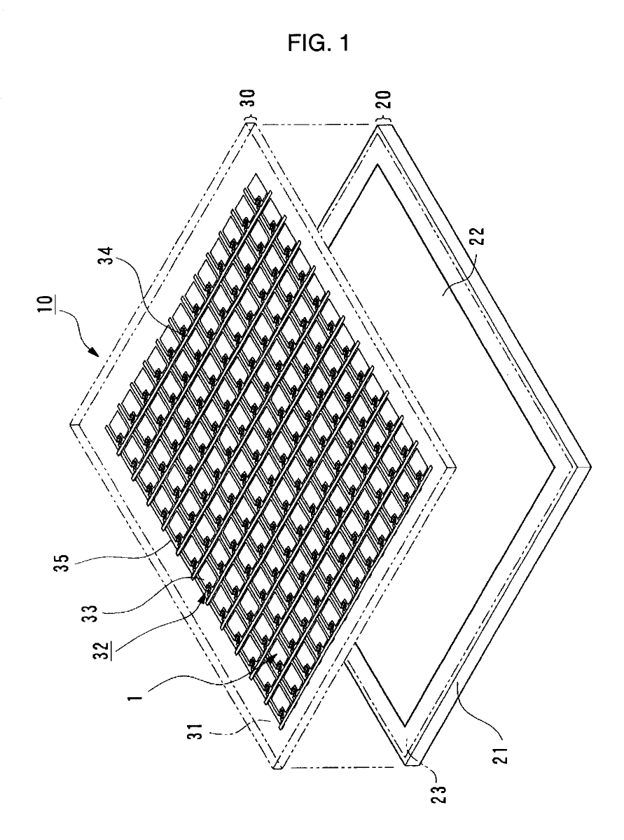

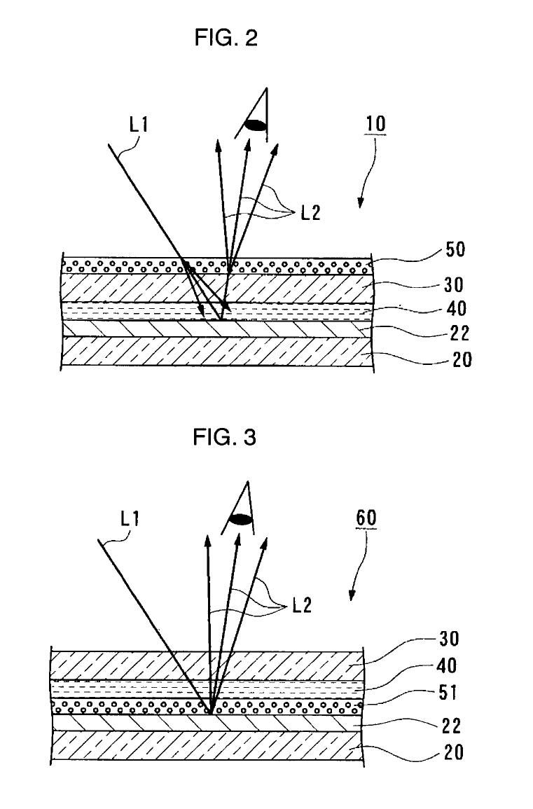

Hereinafter, a first embodiment of the present invention will be described with reference to FIGS. 1 and 2.

FIG. 1 is an exploded perspective view showing a reflective liquid crystal display device according to this embodiment, and FIG. 2 is a sectional view showing a schematic configuration of the reflective liquid crystal display device.

In this embodiment, an active matrix reflective liquid crystal display device, using thin-film transistor (TFT) elements as switching elements, is described below. In FIGS. 1 and 2, the scales of the individual layers and individual members differ from each other in order to illustrate them in a recognizable size. In FIG. 2, electrodes to drive a liquid crystal layer, TFTs, wiring, and other layers are not shown.

As shown in FIG. 1, the reflective liquid crystal display device 10 of this embodiment includes an opposing substrate (one substrate) 20 and an element substrate (the other substrate) 30 facing each other with a liquid crystal layer 40 (not shown in FIG. 1) therebetween. Among the two substrates, the element substrate 30 is placed on the user side (viewing side).

As shown in FIG. 1, the element substrate 30 forming the reflective liquid crystal display device 10 of this embodiment mainly includes a light permeability main body 31, such as a glass substrate, and TFT elements 32 and pixel electrodes 33 formed on the surface of the main body 31. More specifically, many data lines 34 and many scanning lines 35 are provided in a grid pattern on the surface at the liquid crystal layer 40 side of the main body 31. Each of the TFT elements 32 is provided in the vicinity of the intersection of each of the data lines 34 and each of the scanning lines 35. Each of the pixel electrodes 33, which includes a transparent conductive material, such as indium tin oxide (ITO), is connected to each of the TFT elements 32. By viewing the overall surface at the liquid crystal layer 40 side of the element substrate 30, it can be understood that the many pixel electrodes 33 are aligned in a matrix and that, in the reflective liquid crystal display device 10, an area provided with one pixel electrode 33 and one data line 34 and one scanning line 35 which are provided to surround one pixel electrode 33 is regarded as a pixel 1.

On the other hand, the opposing substrate 20 includes a main body 21, a reflective layer 22 including a holographic reflective layer formed on the surface at the liquid crystal layer 40 side of the main body 21, and a common electrode 23. A cholesteric reflective layer can be used instead of the holographic reflective layer.

For example, the holographic reflective layer can selectively reflect only light having a specific wavelength by changing the pitch of interference fringes in some places. Also, the cholesteric reflective layer can do this by changing the pitch of the helix formed by the liquid crystal molecules. Accordingly, these reflective layers can function as a reflective color filter instead of just a reflective layer.

In this embodiment, as shown in FIG. 2, from among the pair of substrates 20 and 30 facing each other with the liquid crystal layer 40 therebetween, a forward scattering film 50 is bonded on the outer surface (user side) of the element substrate 30 placed on the user side. The forward scattering film 50 is formed by, for example, scattering many beads having a refractive index of about 1.4 and a particle diameter of about 4 μm inside an acrylic resin layer having a thickness of about 25 to 30 μm and a refractive index of about 1.48 to 1.49, and is generally used for liquid crystal display units of portable information apparatus and so on. Other embodiments of the invention may include other refractive indices, particle diameters, and thicknesses.

In the liquid crystal display device 10 of this embodiment, a reflective layer creating reflected light having high directivity, such as a holographic reflective layer or a cholesteric reflective layer, is used as the reflective layer 22. However, since the forward scattering film 50 is provided on the viewing side above the reflective layer 22, reflected light L2 scatters as shown in FIG. 2, and thus the intensity distribution of the reflected light L2 can be even more than in the related art. As a result, a liquid crystal display device performing bright display over a wide range of viewing angles can be realized. Further, the viewing angle can be increased simply by bonding the forward scattering film 50 on the upper surface of the element substrate 30, and the above-described advantages can be easily obtained.

[Second Embodiment]

Hereinafter, a second embodiment of the present invention will be described with reference to FIG. 3.

FIG. 3 is a sectional view showing a schematic configuration of a reflective liquid crystal display device of this embodiment. The basic configuration of the reflective liquid crystal display device of this embodiment is the same as in the first embodiment, except for the position at which the light scattering layer is provided. Thus, in FIG. 3, elements common to those in FIG. 2 are denoted by the same reference numerals and the corresponding description will be omitted.

In a reflective liquid crystal display device 60 of this embodiment, the element substrate 30 is placed on the user side and the reflective layer 22, such as a holographic reflective layer or a cholesteric reflective layer, is formed on the opposing substrate 20, as in the first embodiment. In this embodiment, as shown in FIG. 3, an internal scattering overcoat layer 51, which is formed by mixing many beads having a refractive index of about 1.6 in an acrylic resin having a refractive index of about 1.56, is formed on the opposing substrate 20. The internal scattering overcoat layer 51 may be formed either on the upper side or the lower side of the common electrode 23, but has to be formed on the viewing side above the reflective layer 22. Alternatively, the internal scattering overcoat layer 51 may be formed on the upper surface of the liquid crystal layer 40, that is, on the lower surface of the element substrate 30.

Also, in the liquid crystal display device of this embodiment, since the internal scattering overcoat layer 51 is provided on the viewing side above the reflective layer 22, such as the holographic reflective layer or the cholesteric reflective layer, the intensity distribution of the reflected light L2 can be even more than in the known art. Accordingly, a liquid crystal display device that performs bright display over a wide range of viewing angles can be realized, which is the same advantage as in the first embodiment.

[Electronic apparatus]

Examples of electronic apparatus having the liquid crystal display device of the above-described embodiments are described below.

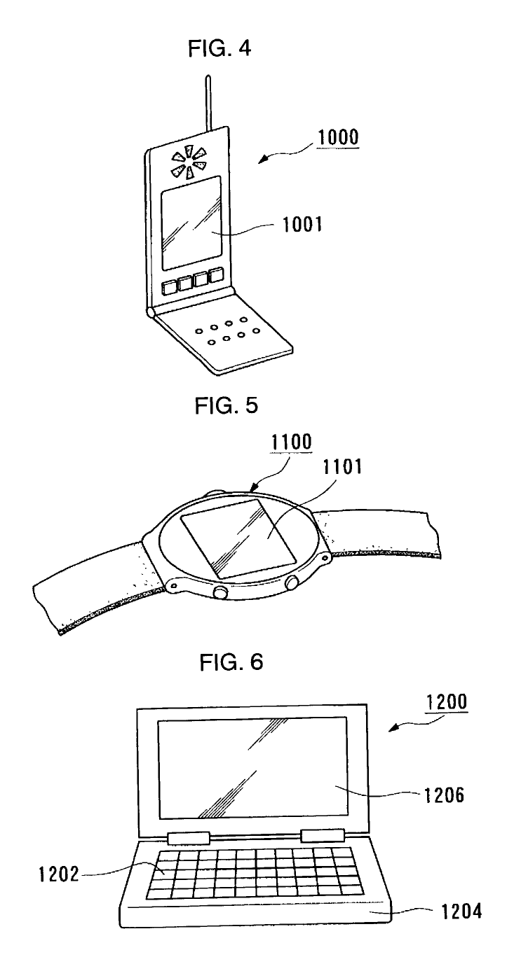

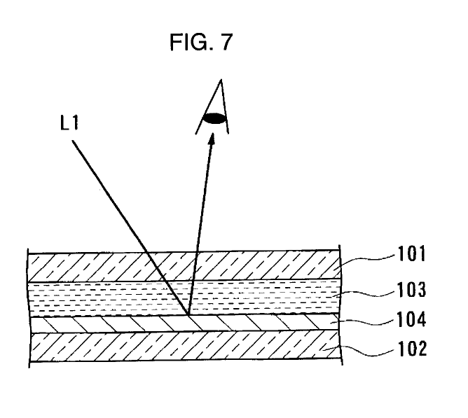

FIG. 4 is a perspective view showing an example of a mobile phone. In FIG. 4, reference numeral 1000 denotes a main body of the mobile phone, and reference numeral 1001 denotes a display unit including the above-described liquid crystal display device.

FIG. 5 is a perspective view showing an example of wristwatch-type electronic apparatus. In FIG. 5, reference numeral 1100 denotes a main body of the wristwatch, and reference numeral 1101 denotes a display unit including the above-described liquid crystal display device.

FIG. 6 is a perspective view showing an example of a portable information processing device, such as a word processor or a personal computer. In FIG. 6, reference numeral 1200 denotes an information processing device, reference numeral 1202 denotes an input unit such as a keyboard, reference numeral 1204 denotes a main body of the information processing device, and reference numeral 1206 denotes a display unit including the above-described liquid crystal display device.

Since the electronic apparatus shown in FIGS. 4 to 6 include the liquid crystal display device of the above-described embodiments, electronic apparatus having a bright liquid crystal display unit over a wide range of viewing angles can be realized.

The technical scope of the present invention is not limited by the above-described embodiments, and various modifications can be achieved without deviating from the scope of the present invention. For example, in the above-described embodiments, a light scattering layer is provided in addition to a reflective layer. Alternatively, the reflective layer itself may have a light scattering function, by forming an uneven surface on the main body of the opposing substrate by using a resin or the like, and then by forming the reflective layer, such as a holographic layer or a cholesteric layer, thereon. The viewing angle can also be increased with this arrangement.

Also, although an example of a reflective liquid crystal display device is described in the above-described embodiments, a transflective liquid crystal display device can be configured by making the above reflective layer function as a half mirror. Further, the present invention can be applied to a passive matrix liquid crystal display device as well as an active matrix liquid crystal display device.

[Advantages]

As described above in detail, according to the present invention, the reflective layer creating reflected light having high directivity, such as the holographic reflective layer or the cholesteric reflective layer, is used. However, since the light scattering layer is provided at the viewing side above the reflective layer, the reflected light scatters, and thus the intensity distribution of the reflected light can be even more than in the related art. As a result, a liquid crystal display device that performs bright display over a wide range of viewing angles can be realized.

What is claimed is:

1. A liquid crystal display device, comprising:
liquid crystal;
a pair of substrates facing each other with the liquid crystal therebetween;
a reflective layer formed on one substrate of the pair of substrates, the reflective layer including a cholesteric reflective layer, another substrate of the pair of substrates being disposed at a viewing side of the device; and
a light scattering layer to scatter light reflected at the reflective layer provided at the viewing side above the reflective layer.

2. A liquid crystal display device, comprising:
liquid crystal;
a pair of substrates facing each other with the liquid crystal therebetween;
a reflective layer formed on one substrate of the pair of substrates, the reflective layer including a holographic reflective layer, another substrate of the pair of substrates being disposed at a viewing side of the device, and
a light scattering layer to scatter light reflected at the reflective layer provided at the viewing side above the reflective layer.

3. The liquid crystal display device according to claim 1, the light scattering layer including a forward scattering film provided on an outer surface of the other substrate.

4. The liquid crystal display device according to claim 1, the light scattering layer being formed on an inner side of the one substrate or the other substrate, the light scattering layer including an internal scattering layer formed by mixing particles into a light permeability layer, a refractive index of the particles being different from that of the light permeability layer.

5. A liquid crystal display device, comprising:
liquid crystal;
a pair of substrates facing each other with the liquid crystal therebetween; and
a reflective layer formed on one substrate of the pair of substrates, the reflective layer including a cholesteric reflective layer, another substrate of the pair of substrates being disposed at a viewing side of the device, an upper surface of the one substrate being uneven and provided with the reflective layer thereon.

6. A liquid crystal display device, comprising:
liquid crystal;
a pair of substrates facing each other with the liquid crystal therebetween; and
a reflective layer formed on one substrate of the pair of substrates, the reflective layer including a holographic reflective layer, another substrate of the pair of substrates being disposed at a viewing side of the device, an upper surface of the one substrate being uneven and provided with the reflective layer thereon.

7. An electronic apparatus, comprising:
the liquid crystal display device according to claim 1.
